(19) United States
(12) Patent Application Publication
(10) Pub. No.: US 2018/0100437 A1
(43) Pub. Date: Apr. 12, 2018

(54) COMBUSTOR IGNITER COOLING

(71) Applicant: General Electric Company, Schenectady, NY (US)

(72) Inventors: Richard Martin DiCintio, Simpsonville, SC (US); Srikanth Chandrudu Kottilingam, Greenville, SC (US)

(21) Appl. No.: 15/289,242

(22) Filed: Oct. 10, 2016

(51) Int. Cl. F02C 7/264; F23R 3/00

(52) U.S. Cl. CPC F02C 7/264; F23R 3/002; F05D 2220/32; F05D 2250/281; F05D 2260/204; F05D 2250/185; F05D 2240/35

(57) ABSTRACT

An igniter assembly and a combustor including an igniter assembly is disclosed herein. The igniter assembly comprises an igniter housing. The igniter housing includes an outer surface, a first end wall and a second end wall. The igniter assembly also includes a preformed cover plate having an inner surface that is attached to the outer surface of the igniter housing. A plurality of micro-cooling channels is formed within at least one of the inner surface of the preformed cover plate and the outer surface of the igniter housing.

### FIELD OF THE TECHNOLOGY

The present invention generally involves an igniter for a combustor. More specifically, the invention relates to a igniter having micro channels for cooling.

### BACKGROUND

During operation of a gas turbine engine, pressurized air from a compressor flows into a head end volume defined within the combustor. The pressurized air flows from the head end volume into an inlet to a corresponding premix passage of a respective fuel nozzle. Fuel is injected into the flow of pressurized air within the premix passage where it mixes with the pressurized air so as to provide a fuel and air mixture to a combustion zone or chamber defined downstream from the fuel nozzle.

An ignition system including an igniter lead disposed within an igniter housing or jacket is typically used to ignite the fuel and air mixture within combustion zone. In particular ignition systems, a portion of the igniter body may extend at least partially into the flow of combustion gases. As such, the igniter housing may be subject to an operational temperature that may cause the igniter lead to deteriorate over time. Therefore, improved cooling of the igniter housing may improve performance of the igniter.

### BRIEF DESCRIPTION OF THE TECHNOLOGY

Aspects and advantages are set forth below in the following description, or may be obvious from the description, or may be learned through practice.

One embodiment of the present disclosure is an igniter assembly. The igniter assembly includes an igniter housing including an outer surface a first end wall and a second end wall and a preformed cover plate having an inner surface that is attached to the outer surface of the igniter housing. A plurality of micro-cooling channels is formed within at least one of the inner surface of the preformed cover plate and the outer surface of the igniter housing.

Another embodiment of the present disclosure is a combustor. The combustor includes a combustion liner defining a radial opening and a combustion chamber therein, an annular flow passage that surrounds the combustion liner and an igniter assembly. The igniter assembly comprises an igniter housing that extends radially through the radial opening. The igniter housing also includes an outer surface a first end wall and a second end wall. The second end wall is disposed within the combustion chamber. A first portion of the igniter housing extends into the combustion chamber and a second portion of the igniter housing is at least partially disposed within the annular flow passage. The igniter assembly further includes a preformed cover plate having an inner surface attached to the outer surface of the igniter housing and the preformed cover plate is at least partially disposed within the combustion chamber. A plurality of micro-cooling channels is formed within at least one of the inner surface of the preformed cover plate and the outer surface of the igniter housing.

Those of ordinary skill in the art will better appreciate the features and aspects of such embodiments, and others, upon review of the specification.

### BRIEF DESCRIPTION OF THE DRAWINGS

A full and enabling disclosure of the of various embodiments, including the best mode thereof to one skilled in the art, is set forth more particularly in the remainder of the specification, including reference to the accompanying figures, in which:

FIG. 1 is a functional block diagram of an exemplary gas turbine that may incorporate various embodiments of the present disclosure;

FIG. 2 is a cross sectional side view of an exemplary ignition system and a portion of an exemplary combustor as may incorporate various embodiments of the present disclosure;

FIG. 3 is a perspective view of a portion of an exemplary igniter housing including a plurality of micro-cooling channels formed therein according to at least one embodiment of the present disclosure;

FIG. 4 is a perspective view of an exemplary preformed cover plate placed over the micro-cooling channels as shown in FIG. 3, according to at least one embodiment of the present disclosure;

FIG. 5 is a side view of the exemplary igniter assembly as shown in FIG. 2, according to at least one embodiment of the present disclosure;

FIG. 6 is a side view of the exemplary igniter assembly as shown in FIG. 2, according to at least one embodiment of the present disclosure; and

FIG. 7 is a perspective view of a portion of an exemplary igniter housing and an exemplary preformed cover plate according to at least one embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” refers to the relative direction that is substantially parallel and/or coaxially aligned to an axial centerline of a particular component, and the term “circumferentially” refers to the relative direction that extends around the axial centerline of a particular component.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Each example is provided by way of explanation, not limitation. In fact, it will be apparent to those skilled in the art that modifications and variations can be made without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents. Although exemplary embodiments of the present disclosure will be described generally in the context of an igniter for a combustor of a land based power generating gas turbine for purposes of illustration, one of ordinary skill in the art will readily appreciate that embodiments of the present disclosure may be applied to any style or type of combustor for a turbomachine and are not limited to combustors or combustion systems for land based power generating gas turbines unless specifically recited in the claims.

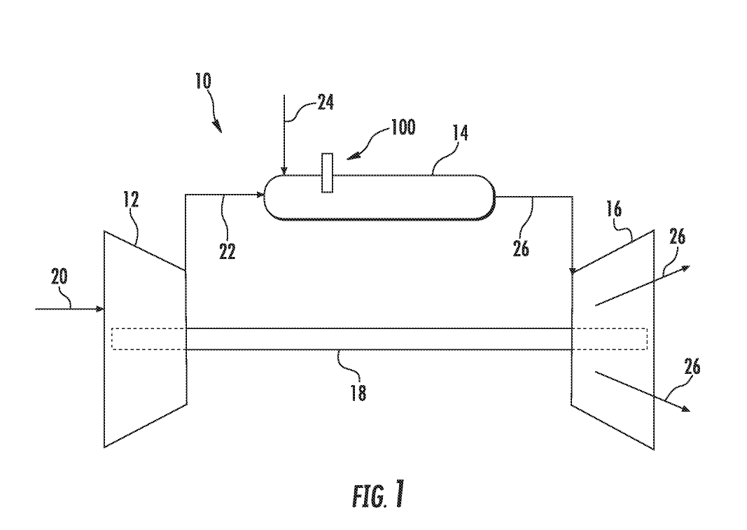

Referring now to the drawings, FIG. 1 illustrates a schematic diagram of an exemplary gas turbine 10. The gas turbine 10 generally includes a compressor 12, at least one combustor 14 disposed downstream of the compressor 12 and a turbine 16 disposed downstream of the combustor 14. Additionally, the gas turbine 10 may include one or more shafts 18 that couple the compressor 12 to the turbine 16.

During operation, air 20 flows into the compressor 12 where the air 20 is progressively compressed, thus providing compressed or pressurized air 22 to the combustor 14. At least a portion of the compressed air 22 is mixed with a fuel 24 within the combustor 14 and burned to produce combustion gases 26. The combustion gases 26 flow from the combustor 14 into the turbine 16, wherein energy (kinetic and/or thermal) is transferred from the combustion gases 26 to rotor blades (not shown), thus causing shaft 18 to rotate. The mechanical rotational energy may then be used for various purposes such as to power the compressor 12 and/or to generate electricity. The combustion gases 26 may then be exhausted from the turbine 16. In particular configurations, an ignition system 100 is used to ignite the compressed air 22 and fuel 24 mixture.

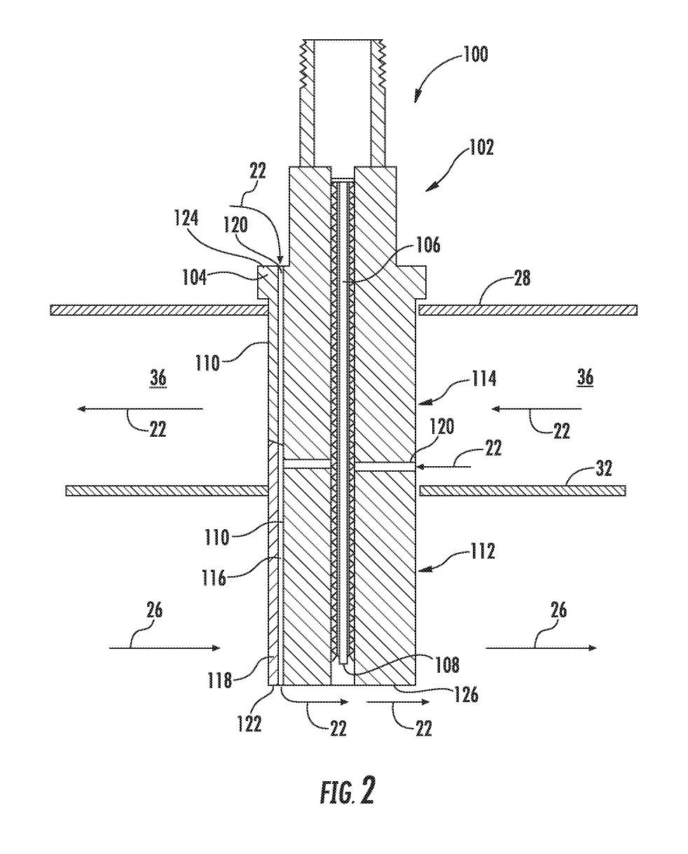

FIG. 2 is a cross sectional side view of an exemplary ignition system 100 and a portion of an exemplary combustor 14 as may incorporate various embodiments of the present disclosure. As shown in FIG. 2, the ignition system 100 generally includes an igniter assembly 102 including an igniter housing or jacket 104, at least one igniter 106, and at least one igniter lead 108. The igniter 106 and/or the igniter lead 108 may be coupled to an exciter (not shown). In other embodiments, the ignition system 100 may comprise, for example, a sparkplug, a laser or torch adapted for installation at least partially inside the combustor 10 to project a spark, laser beam or flame into a combustion chamber of the combustor 14.

In particular embodiments, as shown in FIG. 2, the igniter housing 104 may be configured to mount to a flow sleeve 28 of the combustor 14. The igniter housing 104 may then extend radially inwardly from the flow sleeve 28 and through an radial opening 30 defined in a combustion liner 32 of the combustor 14. The combustion liner 32 may at least partially define a combustion zone or chamber 34 of the combustor 14. An annular flow passage 36 may be defined between the flow sleeve 28 and the combustion liner 32. The annular flow passage 36 may provide for fluid communication between the compressor 12 and a head end volume (not shown) of the combustor 14. The compressed air 22 provided to the head end volume is then mixed with the fuel 24 and burned in the combustion chamber 34 to provide the combustion gases 26. In other embodiments, the igniter housing 104 may be connected to the combustion liner 32 of the combustor 14.

As shown in FIG. 2, the igniter housing 104 may be substantially cylindrical. The igniter housing 104 includes or defines an outer surface or perimeter 110. In particular embodiments, as shown in FIG. 2, a first portion 112 of the igniter housing 104 extends radially through the radial opening 30 of the combustion liner 32 and into the flow of combustion gases 26. In particular embodiments, a second portion 114 of the igniter housing 104 extends radially through the annular flow passage 36.

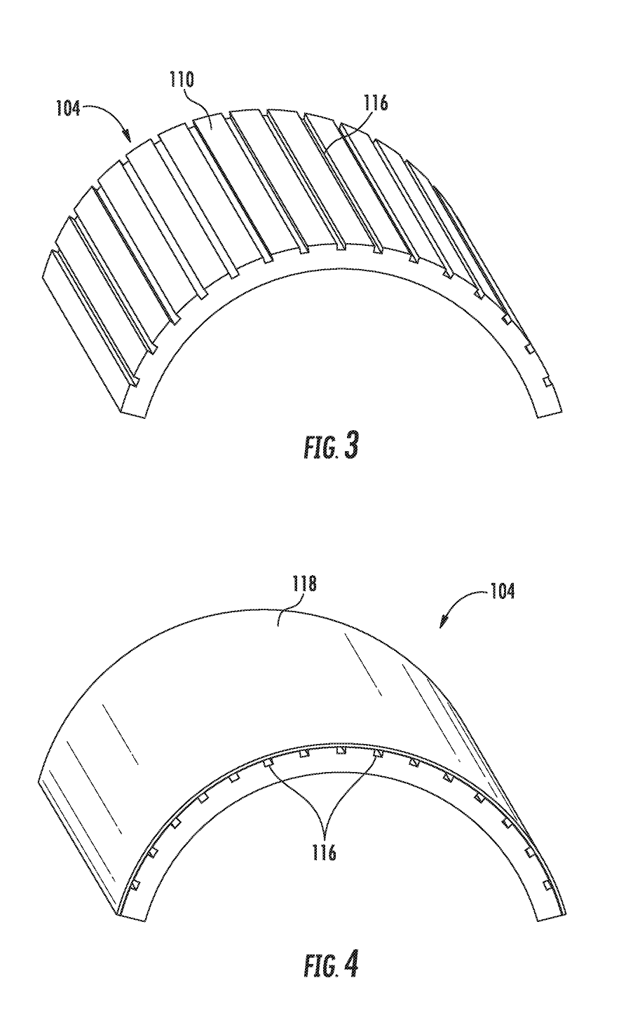

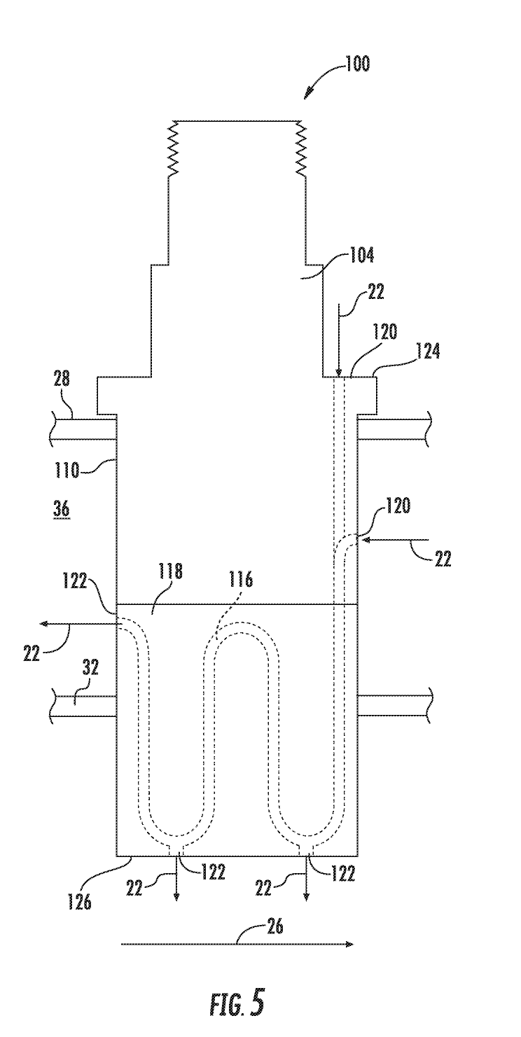

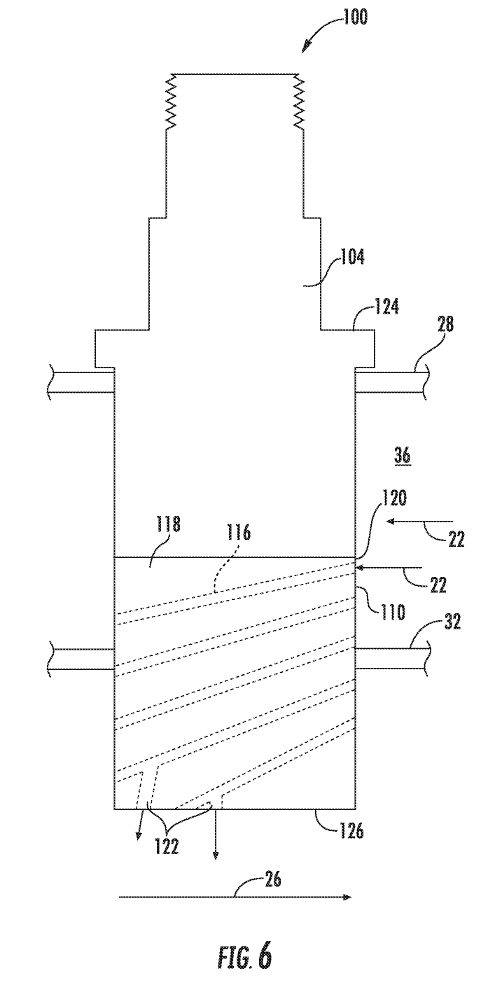

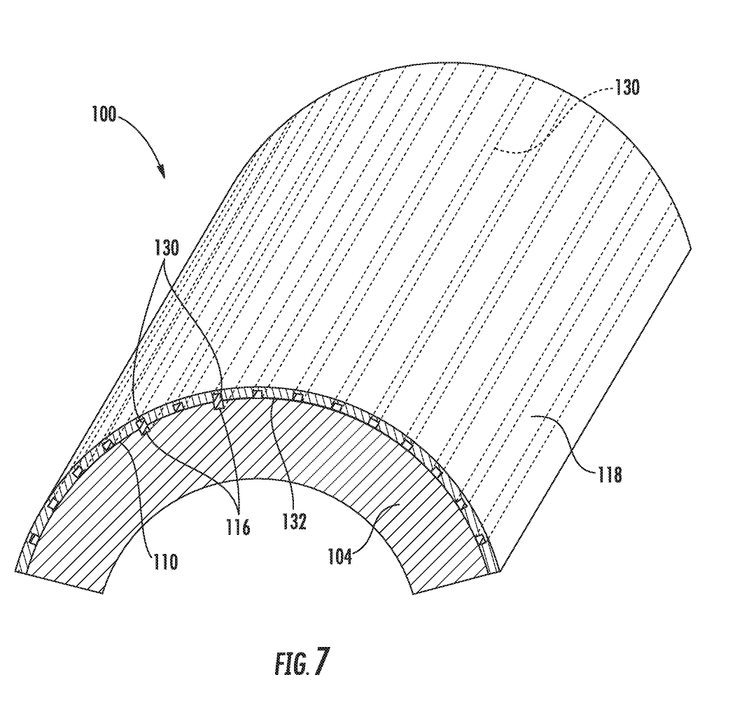

In various embodiments, as shown in FIG. 2, the igniter housing 104 includes one or more micro-cooling channels 116 defined in or formed along the outer surface 110. FIG. 3 provides a perspective view of a portion of the igniter housing 104 including a plurality of micro-cooling channels 116 formed therein according to at least one embodiment of the present disclosure. FIG. 4 is a perspective view of a cover plate or preformed cover plate 118 placed over the micro-cooling channels 116 as shown in FIG. 3 according to at least one embodiment of the present disclosure. FIG. 5 is a side view of the exemplary igniter assembly 102 as shown in FIG. 2 according to at least one embodiment of the present disclosure. FIG. 6 is a side view of the exemplary igniter assembly 102 as shown in FIG. 2 according to at least one embodiment of the present disclosure.

As shown in FIG. 3, the outer surface 110 of the igniter housing 104 is relatively or substantially curved or arcuate. The outer surface 110 of the igniter housing 104 includes at least one, but typically a plurality of the micro-cooling channels 116 formed within the outer surface 110. The plurality of micro-cooling channels 116 may be the same or different in size or shape from each other. In accordance with certain embodiments, the plurality of micro-cooling channels 116 may have a width of between about 100 microns (μm) and about 3 millimeters (mm) and a depth between about 100 μm and about 3 mm, as will be discussed below. For example, the plurality of micro-cooling channels 116 may have a width and/or depth between about 150 μm and about 1.5 mm, between about 250 μm and about 1.25 mm, or between about 300 μm and about 1 mm.

In certain embodiments, the plurality of micro-cooling channels 116 may have a width and/or depth of less than about 50, 100, 150, 200, 250, 300, 350, 400, 450, 500, 600, 700, or 750 μm. The plurality of micro-cooling channels 116 may have circular, semi-circular, oval, curved, rectangular, triangular, or rhomboidal cross-sections. The preceding list is merely illustrative and is not intended to be exhaustive. The width and depth could vary throughout its length. Additionally, in certain embodiments, the plurality of micro-cooling channels 116 may have varying cross-sectional areas. Heat transfer enhancements such as turbulators or dimples may be installed in the plurality of micro-cooling channels 116 as well.

In particular embodiments, as shown in FIGS. 2 and 4 collectively, the preformed cover plate 118 (FIG. 3) is disposed over the outer surface 110 of the igniter housing 104, and more specifically over the plurality of micro-cooling channels 116 to at least partially enclose the plurality of micro-cooling channels 116. The preformed cover plate 118 may be formed of various suitable materials. In one embodiment, the preformed cover plate 118 comprises one or more layers of pre-sintered preform (PSP) foils. In another embodiment, the preformed cover plate 118 comprises one or more layers of sheet metal. It is further contemplated that the preformed cover plate 118 may be formed of both PSP foil(s) and one or more layers of sheet metal. The preformed cover plate 118 is shaped in such a way to form a flush engagement with the outer surface 110 of the igniter housing 104. A flush engagement provides effective sealing and enclosure of the plurality of micro-cooling channels 116. It is contemplated that the plurality of micro-cooling channels 116 is formed in the preformed cover plate 118 as an alternative to, or in combination with, micro-cooling channels formed in the outer surface 110 of the igniter housing 104.

In particular embodiments, as shown in FIG. 5. The plurality of micro-cooling channels 116 may extend along the outer surface 110 beneath the preformed cover plate 118 in a serpentine pattern. In particular embodiments, as shown in FIG. 6, plurality of micro-cooling channels 116 may extend along the outer surface 110 beneath the preformed cover plate 118 in a helical pattern.

As shown collectively in FIGS. 2, 5 and 6, in particular embodiments one or more channel inlets 120 provide for fluid communication between a compressed air source such as the compressor 12 (FIG. 1) and the plurality of micro-cooling channels 116. One or more channel outlets 122 provide for fluid communication out of the micro-cooling channels 116. In particular embodiments, as shown in FIGS. 2 and 5, at least one channel inlet 120 of the one or more channel inlets 120 is defined along a first end wall or surface 124 of the igniter housing 104 outside of the annular flow passage 36. In at least one embodiment, as shown in FIGS. 2 and 6, at least one channel inlet 120 of the one or more channel inlets 120 is defined along the outer surface 110 of the igniter housing 104 in a position that places the at least one channel inlet 120 within and/or in fluid communication with the annular flow passage 36 when the igniter assembly 102 is mounted in the combustor 14.

In particular embodiments, as shown collectively in FIGS. 2, 5 and 6, at least one channel outlet 122 of the one or more channel outlets 122 is defined along a second end wall or surface 126 of the igniter housing 104. In at least one embodiment, as shown in FIG. 5, at least one channel outlet 122 of the one or more channel outlets 122 is defined along the outer surface 110 in a position that places the at least one channel outlet 122 within and/or in fluid communication with the annular flow passage 36.

FIG. 7 provides a perspective view of a portion of the igniter housing 104 of the igniter assembly 102 and an exemplary preformed cover plate 118 according to at least one embodiment of the present disclosure. In particular embodiments, the preformed cover plate 118 defines a plurality of micro-cooling channels 130 in an inner surface 132 of the preformed cover plate 118. The micro-cooling channels 130 comprise any channel that can align with a corresponding air inlet 120 and an air outlet 122 so that a cooling medium such as the compressed air 22 can flow therebetween. The micro-cooling channels 130 can have a variety of cross-sectional shapes and configurations. For example, in some embodiments, the micro-cooling channels 130 can comprise a semi-circular tunnel. In other embodiments, the cross-sectional shape of the micro-cooling channels 130 can be rectangular, circular, or any other geometrical or non-geometrical shape or combinations thereof.

In particular embodiments, the micro-cooling channels 130 may extend along the inner surface 132 of the preformed cover plate in a serpentine pattern. In particular embodiments, the micro-cooling channels 130 may extend along the inner surface 132 of the preformed cover plate in a helical pattern. In particular embodiments, one or more of the plurality of micro-cooling channels 130 defined along the inner surface 132 of the preformed cover plate 118 may be aligned with a respective micro-cooling channel 116 defined along the outer surface of the igniter housing 104.

In operation, a cooling medium such as the compressed air 22 from the compressor 12, enters at least one channel inlet 120 of the one or more channel inlets and flows through the plurality of micro-cooling channels defined beneath the preformed cover plate 118 and/or through the plurality of micro-cooling channels 130 defined along the inner surface 132 of the preformed cover plate 118, thereby transferring thermal energy provided by the combustion gases 26 away from the igniter housing 104 and/or the preformed cover plate 118. In particular embodiments, a portion or all of the cooling medium may be exhausted from the micro-cooling channels 116, 130 into the annular flow passage 36 via one or more of the channel outlets 122 disposed within the annular flow passage 36 so that it may be mixed with the compressed air 22 flowing though the annular flow passage 36 upstream from the combustion chamber 34, thereby increasing the compressed air flow to the head end volume of the combustor 14. In particular embodiments, a portion or all of the cooling medium may be exhausted from the micro-cooling channels 116, 130 via one or more of the channel outlets 122 defined along the second end wall 126 of the igniter housing 104, thereby providing a film of cooling medium to the second end wall 126.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An igniter assembly, comprising:
an igniter housing including an outer surface a first end wall and a second end wall; and
a preformed cover plate having an inner surface attached to the outer surface of the igniter housing;
wherein a plurality of micro-cooling channels is formed within at least one of the inner surface of the preformed cover plate and the outer surface of the igniter housing.

2. The igniter assembly as in claim 1 wherein the plurality of micro-cooling channels is formed in the outer surface of the igniter housing beneath the preformed cover plate.

3. The igniter assembly as in claim 1, wherein the plurality of micro-cooling channels is formed in the inner surface of the preformed cover plate.

4. The igniter assembly as in claim 1, wherein a portion of at least one micro-cooling channel of the plurality of micro-cooling channels is partially formed in the outer surface of the igniter housing and is partially formed in the inner surface of the preformed cover plate.

5. The igniter assembly as in claim 1, wherein the preformed cover plate comprises one or more layers of pre-sintered preform foils.

6. The igniter assembly as in claim 1, wherein the preformed cover plate comprises one or more layers of sheet metal.

7. The igniter assembly as in claim 1, wherein the preformed cover plate comprises one or more layers of pre-sintered preform foils and one or more layers of sheet metal.

8. The igniter assembly as in claim 1, wherein the preformed cover plate is flush with the outer surface of the igniter housing.

9. The igniter assembly as in claim 1, wherein one or more micro-cooling channels of the plurality of micro-cooling channels is formed in serpentine pattern.

10. The igniter assembly as in claim 1, wherein one or more micro-cooling channels of the plurality of micro-cooling channels is formed in helical pattern.

11. The igniter assembly as in claim 1, wherein the plurality of micro-cooling channels is in fluid communication with at least one channel inlet and at least one channel outlet.

12. The igniter assembly as in claim 11, wherein the at least one channel inlet is defined along a first end wall of the igniter housing.

13. The igniter assembly as in claim 11, wherein the at least one channel inlet is defined along the outer surface of the igniter housing.

14. The igniter assembly as in claim 11, wherein the at least one channel outlet is defined along a second end wall of the igniter housing.

15. The igniter assembly as in claim 11, wherein the at least one channel outlet is defined along the outer surface of the igniter housing.

16. A combustor, comprising:
a combustion liner defining a radial opening and a combustion chamber therein;
an annular flow passage surrounding the combustion liner; and
an igniter assembly, wherein the igniter assembly comprises:
an igniter housing that extends radially through the radial opening, the igniter housing including an outer surface a first end wall and a second end wall, wherein the second end wall is disposed within the combustion chamber, wherein a first portion of the igniter housing extends into the combustion chamber and a second portion of the igniter housing is at least partially disposed within the annular flow passage; and
a preformed cover plate having an inner surface attached to the outer surface of the igniter housing, wherein the preformed cover plate is at least partially disposed within the combustion chamber;
wherein a plurality of micro-cooling channels is formed within at least one of the inner surface of the preformed cover plate and the outer surface of the igniter housing.

17. The combustor as in claim 16, wherein the plurality of micro-cooling channels is formed in the outer surface of the igniter housing beneath the preformed cover plate.

18. The combustor as in claim 16, wherein the plurality of micro-cooling channels is formed in the inner surface of the preformed cover plate adjacent to the outer surface of the igniter housing.

19. The combustor as in claim 16, wherein a first portion of at least one micro-cooling channel of the plurality of micro-cooling channels is formed in the outer surface of the igniter housing and a second portion of the same micro-cooling channel is formed in the inner surface of the preformed cover plate.

20. The combustor as in claim 16, wherein the preformed cover plate comprises at least one or more layers of pre-sintered preform foils.

21. The combustor as in claim 16, wherein the preformed cover plate comprises one or more layers of sheet metal.

22. The combustor as in claim 16, wherein the preformed cover plate comprises one or more layers of pre-sintered preform foils and one or more layers of sheet metal.

23. The combustor as in claim 16, wherein the preformed cover plate is flush with the outer surface of the igniter housing.

24. The combustor as in claim 16, wherein one or more micro-cooling channels of the plurality of micro-cooling channels is formed in serpentine pattern.

25. The combustor as in claim 16, wherein one or more micro-cooling channels of the plurality of micro-cooling channels is formed in helical pattern.

26. The combustor as in claim 16, wherein the plurality of micro-cooling channels is in fluid communication with at least one channel inlet and at least one channel outlet.

27. The combustor as in claim 27, wherein the at least one channel inlet is defined along a first end wall of the igniter housing.

28. The combustor as in claim 27, wherein the at least one channel inlet is defined in the outer surface of the igniter housing along the second portion of the igniter housing and is in fluid communication with the annular flow passage.

29. The combustor as in claim 27, wherein the at least one channel outlet is defined along the second end wall of the igniter housing and is in fluid communication with the combustion chamber.

30. The combustor as in claim 27, wherein the at least one channel outlet is defined in the outer surface of the igniter housing along the second portion of the igniter housing and is in fluid communication with the annular flow passage.
